(19) United States
(12) Patent Application Publication
(10) Pub. No.: US 2025/0110508 A1
(43) Pub. Date: Apr. 3, 2025

(54) CONTROL DEVICE FOR MOVING BODY, CONTROL METHOD FOR MOVING BODY, AND STORAGE MEDIUM

(71) Applicant: HONDA MOTOR CO., LTD., Tokyo (JP)

(72) Inventor: Sango Matsuzaki, Wako-shi (JP)

(21) Appl. No.: 18/897,303

(22) Filed: Sep. 26, 2024

(30) Foreign Application Priority Data
Sep. 29, 2023 (JP) 2023-169632

(51) Int. Cl. G05D 1/646; G05D 1/65; G05D 1/686; G05D 105/20; G05D 111/10

(52) U.S. Cl. CPC G05D 1/646; G05D 1/65; G05D 1/686; G05D 2105/20; G05D 2111/10

(57) ABSTRACT

A control device for a moving body includes a storage medium configured to store computer-readable instructions, and a processor connected to the storage medium, wherein the processor executes the computer-readable instructions to recognize a surrounding situation of a moving body based at least on an image of the surrounding situation of the moving body, to generate a route from the moving body to a destination based on the recognized surrounding situation and the set destination, to determine whether or not the generated route is within a predetermined region defined by a current position of the moving body and the destination, to control the moving body so that the moving body moves along the generated route to the destination, and to turn the moving body on a spot and to regenerate a route from the moving body that has turned on the spot to the destination when it is determined that the route deviates from the predetermined region.

### CROSS-REFERENCE TO RELATED APPLICATION

Priority is claimed on Japanese Patent Application No. 2023-169632, filed Sep. 29, 2023, the content of which is incorporated herein by reference.

### BACKGROUND

### Field of the Invention

The present invention relates to a control device for a moving body, a control method for a moving body, and a storage medium.

### Description of Related Art

Conventionally, robots that guide users to desired positions or transport luggage are known (refer to, for example, Japanese Unexamined Patent Application, First Publication No. 2012-111011). The above robot refers to a movement speed database that associates maximum movement speeds with each area in an environment, and moves so that the set maximum movement speed is an upper limit of the movement speed.

However, when a route to a destination is generated, conventional robots may generate inefficient routes without changing the orientation of the robot.

### SUMMARY

The present invention has been made taking these circumstances into consideration, and one of objectives thereof is to provide a control device for a moving body, a control method for a moving body, and a storage medium that can curb generation of inefficient routes in terms of orientation of a robot when a route to a destination is generated.

The control device for a moving body, the control method for a moving body, and the storage medium according to the present invention employ the following configuration.

(1): A control device for a moving body according to an aspect of the present invention includes a storage medium configured to store computer-readable instructions, and a processor connected to the storage medium, wherein the processor executes the computer-readable instructions to recognize a surrounding situation of a moving body based at least on an image of the surrounding situation of the moving body, to generate a route from the moving body to a destination based on the recognized surrounding situation and the set destination, to determine whether or not the generated route is within a predetermined region defined by a current position of the moving body and the destination, to control the moving body so that the moving body moves along the generated route to the destination, and to turn the moving body on a spot and to regenerate a route from the moving body that has turned on the spot to the destination when it is determined that the route deviates from the predetermined region.

(2): In the aspect of (1), the processor may determine whether or not the regenerated route is within the predetermined region, and when it is determined that the regenerated route is within the predetermined region, the processor may control the moving body so that the moving body moves along the regenerated route to the destination.

(3): In the aspect of (1), the processor may determine whether or not the regenerated route is within the predetermined region, and when it is determined that the regenerated route deviates from the predetermined region, the processor may control the moving body so that the moving body moves along the regenerated route to a vicinity of a boundary of the predetermined region, turn the moving body on the spot in the vicinity of the boundary of the predetermined region, and generate a route from the moving body that has turned on the spot to the destination.

(4): In the aspect of (1), the predetermined region may be a region which represents a range within a predetermined distance from a reference line that connects the current position of the moving body and the destination.

(5): In the aspect of (1), the moving body may be operated in either a following mode in which the moving body moves to follow a user, or a guide mode in which the moving body moves in front of the user at a moving speed corresponding to that of the user.

(6): In the aspect of (5), when the moving body is operated in the following mode, the destination may be the user or a point within a predetermined range from the user.

(7): In the aspect of (5), when the moving body is operated in the guidance mode, the destination may be a point set by the user or a point within a predetermined range in front of the user.

(8): In the aspect of (5), when the moving body is operated in the guidance mode, the destination may be a temporary point that is temporarily set to reach a final point set by the user.

(9): According to a control method for a moving body according to another aspect of the present invention, a computer recognizes a surrounding situation of a moving body based at least on an image of the surrounding situation of the moving body, generates a route from the moving body to a destination based on the recognized surrounding situation and the set destination, determines whether or not the generated route is within a predetermined region defined by a current position of the moving body and the destination, controls the moving body so that the moving body moves along the generated route to the destination, and turns the moving body on a spot and regenerates a route from the moving body that has turned on the spot to the destination when it is determined that the route deviates from the predetermined region.

(10): According to a computer-readable non-primary storage medium according to another aspect of the present invention, a computer is caused to recognize a surrounding situation of a moving body based at least on an image of the surrounding situation of the moving body, to generate a route from the moving body to the destination based on the recognized surrounding situation and the set destination, to determine whether or not the generated route is within a predetermined region defined by a current position of the moving body and the destination, to control the moving body so that the moving body moves along the generated route to the destination, and to turn the moving body on a spot and to regenerate a route from the moving body that has turned on the spot to the destination when it is determined that the route deviates from the predetermined region.

According to the aspects of (1) to (10), when a route to a destination is generated, it is possible to curb generation of an inefficient route in terms of orientation of a robot.

### BRIEF DESCRIPTION OF THE DRAWINGS

FIG. 1 is a diagram showing an example of a configuration of a moving body system including a moving body.

FIG. 2 is a diagram for describing an example of a usage aspect of the moving body.

FIG. 3 is a diagram for describing a guidance mode.

FIG. 4 is a perspective view showing the moving body.

FIG. 5 is a diagram showing an example of a functional configuration of the moving body.

FIG. 6 is a diagram showing an example of a route generated by a route generation part.

FIG. 7 is a diagram showing an example of a route regenerated by the route generation part.

FIG. 8 is a diagram for describing a process performed when a route regenerated by the route generation part deviates from a predetermined region.

FIG. 9 is another diagram for describing the process performed when the route regenerated by the route generation part deviates from a predetermined region.

FIG. 10 is a flowchart showing an example of a flow of a process performed by a control device.

### DESCRIPTION OF EMBODIMENTS

Hereinafter, with reference to the drawings, embodiments of a control device for a moving body, a control method for a moving body, and a storage medium according to the present invention will be described.

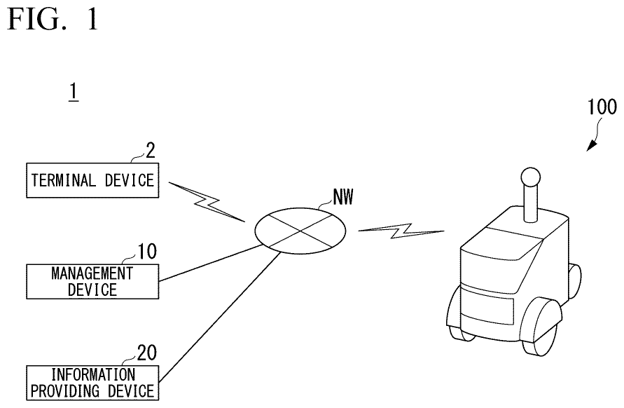

FIG. 1 is a diagram showing an example of a configuration of a moving body system 1 including a moving body 100. The moving body system 1 includes, for example, one or more terminal devices 2, a management device 10, an information providing device 20, and one or more mobile objects 100. They communicate, for example, via a network NW. The network NW is any network such as a LAN, a WAN, or an Internet line.

### [Terminal Device]

The terminal device 2 is, for example, a computer device such as a smartphone or a tablet terminal. For example, on the basis of a user's operation, the terminal device 2 requests provision of authority to use the moving body 100 from the management device 10, or obtains information indicating that permission to use the moving body 100 has been granted.

### [Management Device]

The management device 10 grants a user of the terminal device 2 the authority to use the moving body 100 in response to a request from the terminal device 2, and manages reservations for use of the moving body 100. The management device 10 generates and manages schedule information that associates, for example, pre-registered user identification information with a date and time of reservation for use of the moving body 100.

### [Information Providing Device]

The information providing device 20 provides the moving body 100 with information on a position of the moving body 100, a region in which the moving body 100 moves, and map information around the region. The information providing device 20 may generate a route to a destination of the moving body 100 in response to a request from the moving body 100 and may provide the generated route to the moving body 100.

### [Moving Body]

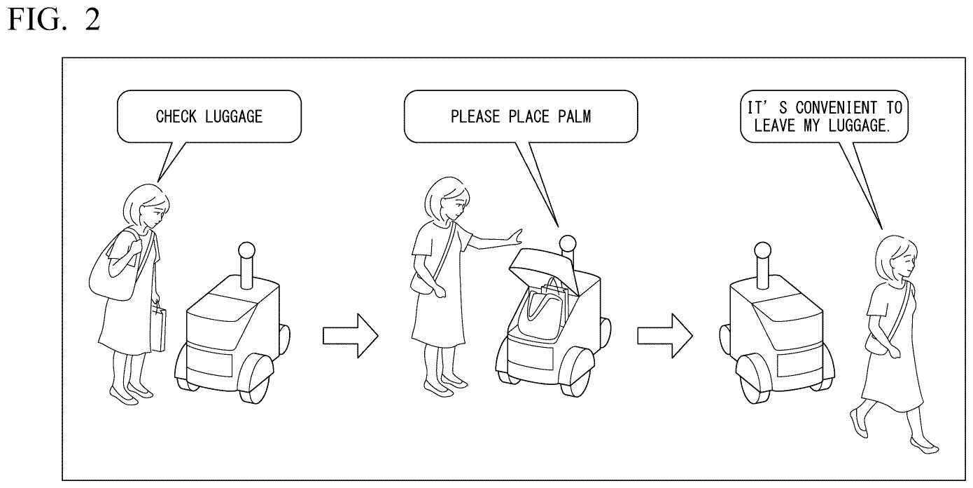

The moving body 100 is used by a user in the following aspect. FIG. 2 is a diagram for describing an example of a usage aspect of the moving body 100. The moving body 100 is disposed, for example, at a predetermined position in a facility or a town. When the user wants to use the moving body 100, the user can start using the moving body 100 by operating an operation part (not shown) of the moving body 100 or can start using the moving body 100 by operating the terminal device 2. For example, when the user goes shopping and has a lot of luggage, the user starts using the moving body 100 and puts the luggage in an accommodation part of the moving body 100.

Then, the moving body 100 moves together with the user so as to autonomously follow the user. The user can continue shopping or move on to the next destination with the luggage accommodated in the moving body 100. For example, the moving body 100 moves along with the user on a sidewalk or a crosswalk on a roadway. The moving body 100 can move in regions in which pedestrians can pass through, such as roadways and sidewalks. For example, the moving body 100 may be used in indoor or outdoor facilities or private grounds, such as shopping centers, airports, parks, and theme parks, and is capable of moving through regions in which pedestrians can pass through.

The moving body 100 may be capable of moving autonomously in a mode such as a guidance mode or an emergency mode in addition to (or instead of) the following mode in which it follows the user as described above.

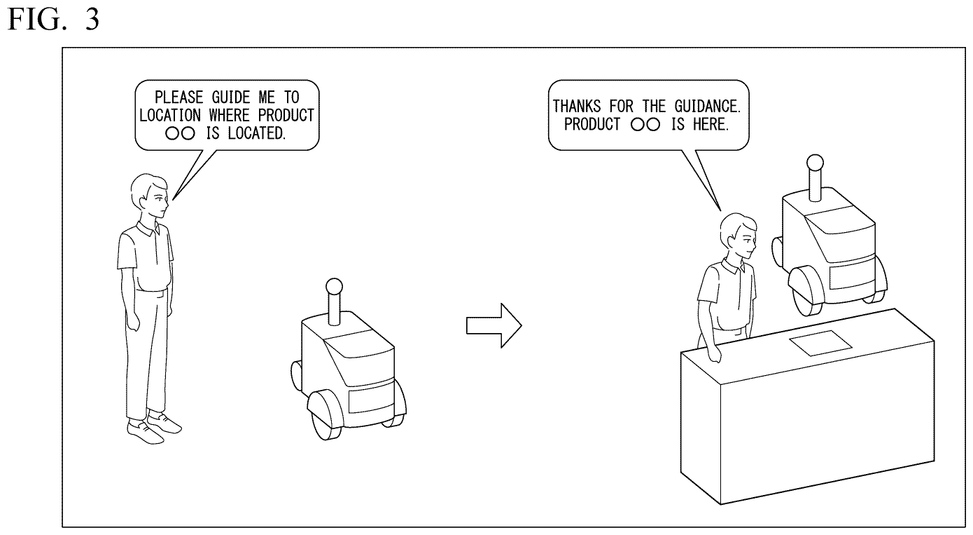

FIG. 3 is a diagram for describing the guidance mode. The guidance mode is a mode for guiding the user to a destination designated by the user, and is a mode for guiding the user by autonomously moving in front of the user at a moving speed of the user. As shown in FIG. 3, when the user is searching for a specific product in a shopping center, if the user requests the moving body 100 to guide the user to a position of a desired product, the moving body 100 guides the user to the position of the product. Thus, the user can easily find the desired product. When the moving body 100 is used in a shopping center, the moving body 100 or the information providing device 20 holds information in which positions of products, stores, and facilities within the shopping center are associated with map information, as well as map information of the shopping center. This map information includes detailed map information such as widths of roads and pathways.

The emergency mode is a mode in which when something happens to the user while it moves with the user (for example, when the user falls), it moves autonomously to seek help from nearby people or facilities in order to help the user. Furthermore, in addition to (or instead of) following or guiding as described above, the moving body 100 may move while a moderate distance from the user is maintained.

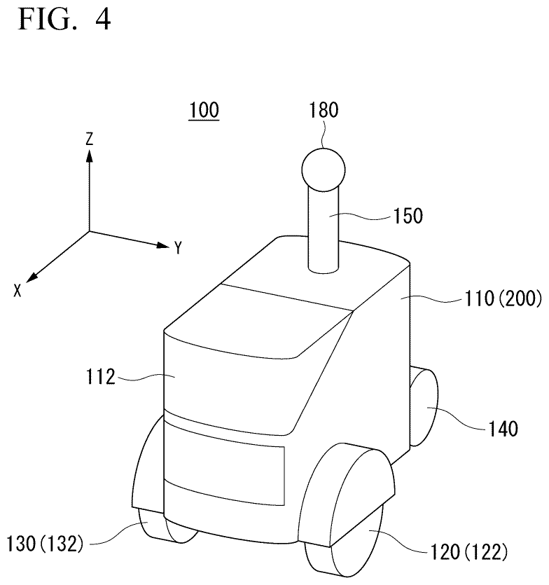

FIG. 4 is a perspective view showing the moving body 100. In the following description, a forward direction of the moving body 100 is defined as a positive x direction, a backward direction of the moving body 100 is defined as a negative x direction, for a width direction of the moving body 100, based on the positive x direction, a left direction thereof is defined as a positive y direction, and a right direction is defined as a negative y direction, and a height direction of the moving body 100 which is perpendicular to the x and y directions is defined as a positive z direction.

The moving body 100 includes, for example, a base body 110, a door part 112 provided on the base body 110, and wheels (a first wheel 120, a second wheel 130, and a third wheel 140) assembled on the base body 110. For example, a user can open the door part 112 and can put luggage in or remove the luggage from the accommodation part provided in the base body 110. The first wheel 120 and the second wheel 130 are driving wheels, and the third wheel 140 is an auxiliary wheel (a driven wheel). The moving body 100 may be capable of moving using a configuration other than wheels, such as caterpillars.

A cylindrical support 150 that extends in the positive z direction is provided on a surface of the base body 110 in the positive z direction. A camera 180 that captures images of surroundings of the moving body 100 is provided at an end portion of the support 150 in the positive z direction. A position at which the camera 180 is provided may be any position different from the above.

The camera 180 is, for example, a camera capable of capturing images of a wide angle (for example, 360 degrees) around the moving body 100. The camera 180 may include a plurality of cameras. The camera 180 may be realized, for example, by combining a plurality of 120-degree cameras or a plurality of 60-degree cameras.

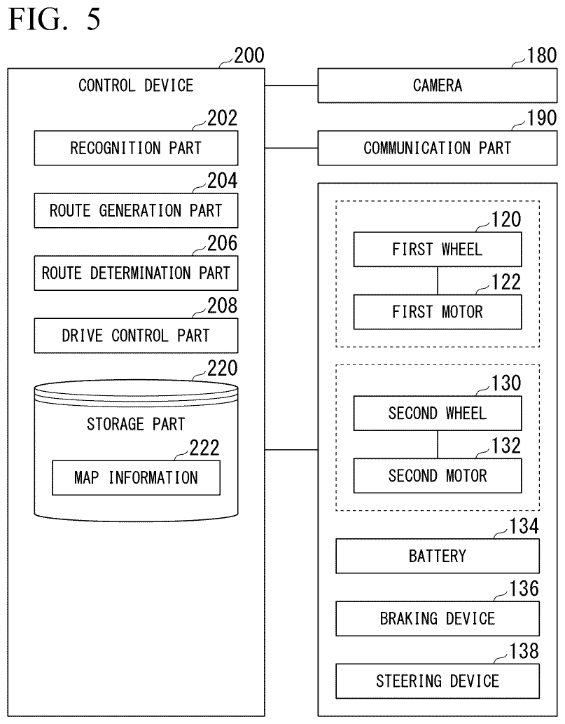

FIG. 5 is a diagram showing an example of a functional configuration of the moving body 100. In addition to the functional configuration shown in FIG. 4, the moving body 100 further includes a first motor 122, a second motor 132, a battery 134, a braking device 136, a steering device 138, a communication part 190, and a control device 200. The first motor 122 and the second motor 132 are operated by power supplied to the battery 134. The first motor 122 drives the first wheel 120, and the second motor 132 drives the second wheel 130. The first motor 122 may be an in-wheel motor provided on a wheel of the first wheel 120, and the second motor 132 may be an in-wheel motor provided on a wheel of the second wheel 130.

The braking device 136 outputs a brake torque to each of the wheels on the basis of an instruction from the control device 200. The steering device 138 includes an electric motor. The electric motor, for example, applies a force to a rack and pinion mechanism on the basis of an instruction from the control device 200 to change a direction of the first wheel 120 or the second wheel 130, thereby changing a course of the moving body 100.

The communication part 190 is a communication interface for communicating with the terminal device 2, the management device 10, or the information providing device 20.

### [Control Device]

The control device 200 includes, for example, a recognition part 202, a route generation part 204, a route determination part 206, a drive control part 208, and a storage part 220. The recognition part 202, the route generation part 204, the route determination part 206, and the drive control part 208 are realized by, for example, a hardware processor such as a central processing unit (CPU) executing a program (software). Some or all of these components may be realized by hardware (including circuitry) such as a large scale integration (LSI), an application specific integrated circuit (ASIC), a field-programmable gate array (FPGA), or a graphics processing unit (GPU), and may be realized by a combination of software and hardware. The program may be stored in advance in a storage device (a storage device having a non-transient storage medium) such as a hard disk drive (HDD) or a flash memory, and may be stored in a removable storage medium (a non-transient storage medium) such as a DVD or a CD-ROM, and may be installed by mounting the storage medium in the drive device. The storage part 220 is realized by a storage device such as a HDD, a flash memory, and a random access memory (RAM). The storage part 220 stores map information 222 referenced by the moving body 100. The map information 222 is, for example, map information on a position of the moving body 100 provided by the information providing device 20, a region in which the moving body 100 moves, the surroundings of the region, and the like. A part or whole of the functional configuration included in the control device 200 may be included in another device. For example, the other device and the moving body 100 may communicate with each other and may cooperate to control the moving body 100.

The recognition part 202 recognizes states such as positions (distances from the moving body 100 and directions relative to the moving body 100) and speeds and accelerations of objects in the vicinity of the moving body 100 on the basis of, for example, images captured by the camera 180. The objects include traffic participants, obstacles present in facilities or on roads, or the like. The recognition part 202 recognizes and tracks the user of the moving body 100. For example, the recognition part 202 tracks the user on the basis of an image (for example, a facial image of the user) captured of the user registered when the user uses the moving body 100, or a facial image of the user (or features obtained from the facial image of the user) provided by the terminal device 2 or the management device 10. The recognition part 202 recognizes a gesture made by the user. The moving body 100 may have a detection part other than a camera, such as a radar device or a LIDAR. In this case, the recognition part 202 recognizes a situation around the moving body 100 using detection results from the radar device or LIDAR instead of (or in addition to) images.

The route generation part 204 generates a route to a destination on the basis of situations around the moving body 100 recognized by the recognition part 202. Here, when the moving body 100 is in the following mode, the destination refers to the user to be followed up, or a point within a predetermined range from the user. For example, the route generation part 204 may set a predetermined point diagonally behind the user as the destination so that the moving body 100 can follow the user and be visible to the user. In addition, for example, the route generation part 204 may determine the destination to keep a predetermined distance on the basis of walking speed of the user in order to prevent the moving body 100 from becoming too far away from the user. When in the guidance mode, for example, the destination refers to a point of a product or facility set by the user. In this case, the user identifies a point of a product or facility, and the moving body 100 combines the point of the identified product or facility with the map information 222, and sets the point of the identified product or facility as the destination as a result of the combination. In addition, in the case of the guidance mode, when the point set by the user is far from a current position of the moving body 100, the route generation part 204 may set the point set by the user as the final destination, and may set a point within a predetermined range from the current position as a temporary destination. In addition, in the guidance mode, the user does not necessarily have to set a destination, and the moving body 100 may predict a direction in which the user will move and may autonomously move in front of the user at a speed that matches a user's movement speed. At this time, the route generation part 204 may set the destination of the moving body 100 as a point within a predetermined range in front of the user. The route is a route that allows the moving body 100 to reasonably reach the destination in consideration of a forward direction of the moving body 100 (that is, the x direction of the moving body 100). For example, a distance to the destination, a time it takes to reach the destination, ease of travel of the route, and the like are scored, and routes of which individual scores and combined scores thereof are equal to or greater than a threshold value are derived. The route may be generated by any algorithm that takes into account at least the forward direction of the moving body 100. The process performed by the route determination part 206 will be described below in detail.

The drive control part 208 controls the motors (the first motor 122 and the second motor 132), the braking device 136, and the steering device 138 so that the moving body 100 travels along the route generated by the route generation part 204.

### [Route Regeneration]

When a route is generated by the route generation part 204, the route determination part 206 determines whether or not the generated route is within a predetermined region defined by the current position of the moving body 100 and the destination. More specifically, the route determination part 206 determines whether or not the generated route is within a predetermined region which represents a range within a predetermined distance from a reference line connecting the current position of the moving body 100 and the destination. In other words, the predetermined region can be considered as a determination region for determining whether or not the route generated by the route generation part 204 is an inefficient route for reaching the destination from the current position of the moving body 100.

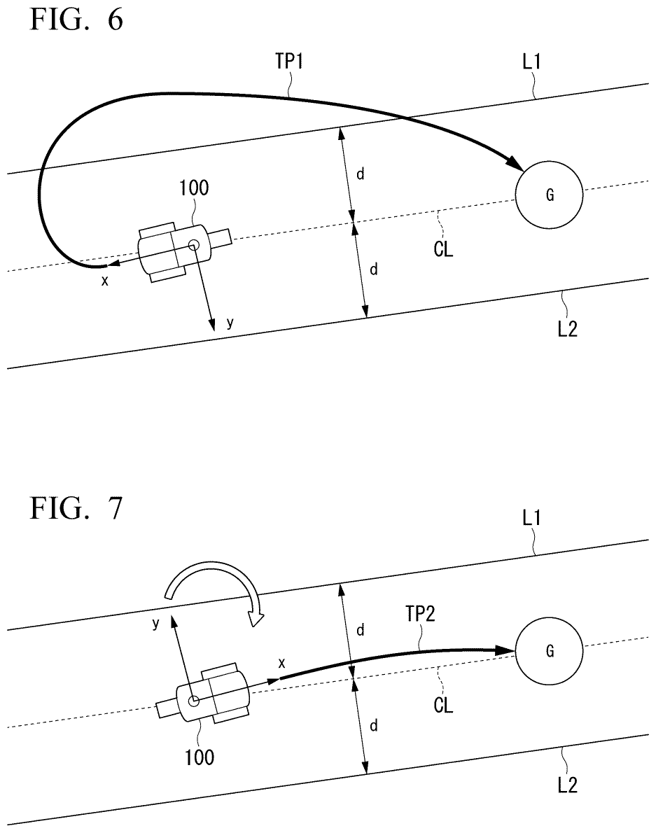

FIG. 6 is a diagram showing an example of a route generated by the route generation part 204. In FIG. 6, a symbol TP1 represents a route to destination G generated by route generation part 204, a symbol CL represents a reference line that connects the current position of moving body 100 and the destination, and a symbol d represents a predetermined distance for defining the predetermined region. That is, the route determination part 206 determines whether or not the generated route TP1 is within a predetermined region which is a region representing a range within a predetermined distance d from the reference line RL. In the case of FIG. 6, the predetermined region represents a region surrounded by straight lines L1 and L2 that are a predetermined distance d away from the reference line RL, and the route determination part 206 determines that the generated route TP1 deviates from the predetermined region.

When the route determination part 206 determines that the generated route TP1 deviates from the predetermined region, the drive control part 208 turns the moving body 100 on the spot by a predetermined angle, and the route generation part 204 regenerates a route from the moving body 100 that has turned on the spot to the destination G. The predetermined angle in this case may be, for example, any angle that reduces an angular difference between the forward direction (the x direction) of the moving body 100 and the direction toward the destination G, or may be an angle for aligning these directions.

FIG. 7 is a diagram showing an example of a route regenerated by the route generation part 204. FIG. 7 shows, as an example, a situation in which the moving body 100 turns on the spot in the scene shown in FIG. 6, and the route generation part 204 regenerates a route TP2 from the moving body 100 that has turned on the spot to the destination G. When the route is regenerated by the route generation part 204, the route determination part 206 determines whether or not the regenerated route is within the above-described predetermined region, and when the it is determined that the regenerated route is within the above-described predetermined region by the route determination part 206, the drive control part 208 controls the moving body 100 so that the moving body 100 moves along the regenerated route to the destination. In the case of FIG. 7, since the regenerated route TP2 is within the predetermined region, the drive control part 208 moves the moving body 100 to the destination G along the route TP2. Thus, it is possible to prevent the moving body 100 from being moved along the inefficient (long) route TP1, and to move the moving body 100 along the more efficient route TP2.

Even when the route is regenerated, due to the presence of obstacles or the like, the regenerated route may not necessarily be within the predetermined region, and may be an inefficient route for the moving body 100. Therefore, as described below, when the regenerated route deviates from the predetermined region again, the drive control part 208 controls the moving body 100 to move along the regenerated route to a vicinity of a boundary of the predetermined region, and turns the moving body 100 on the spot in the vicinity of the boundary of the predetermined region. Then, the route generation part 204 generates a route from the moving body 100 that has turned on the spot to the destination.

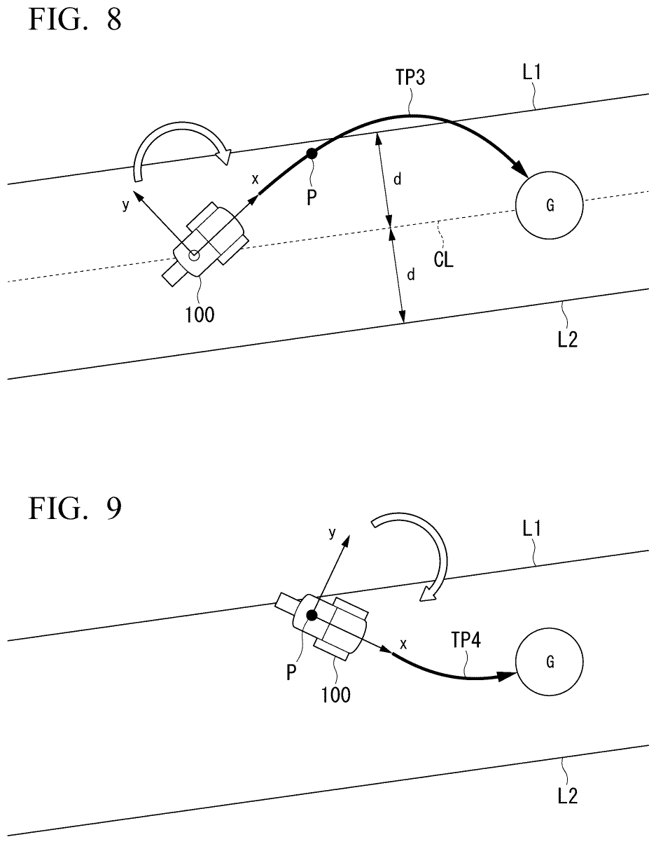

FIG. 8 is a diagram for describing a process that is performed when the route regenerated by the route generation part 204 deviates from the predetermined region. FIG. 8 shows, as an example, a situation in which the moving body 100 turns on the spot in the scene shown in FIG. 6, and the route generation part 204 regenerates a route TP3 from the moving body 100 that has turned on the spot to the destination G. When the route TP3 is regenerated by the route generation part 204, the route determination part 206 determines whether or not the regenerated route TP3 is within the above-described predetermined region, and in the case of FIG. 8, the route determination part 206 determines that the regenerated route TP3 deviates from the predetermined region. Therefore, the drive control part 208 moves the moving body 100 along the regenerated route to a point P in the vicinity of the boundary of the predetermined region, and at the point P, the drive control part 208 turns the moving body 100 on the spot. In this case, the point P is defined as, for example, a point on the regenerated route and a predetermined distance away from the boundary of the predetermined region.

FIG. 9 is another diagram for describing the process that is performed when the route regenerated by the route generation part 204 deviates from the predetermined region. As an example, FIG. 9 shows a situation in which, in the scene shown in FIG. 8, the moving body 100 moves to point P, performs a turn on the spot at the point P, and the route generation part 204 regenerates a route TP4 from the moving body 100 that has made the turn on the spot to the destination. When the route TP4 is regenerated by route generation part 204, the route determination part 206 determines whether or not the regenerated route TP4 is within the above-described predetermined region, and in the case of FIG. 8, the route determination part 206 determines that the regenerated route TP4 is within the predetermined region. Therefore, the drive control part 208 moves the moving body 100 along the regenerated route TP4 to the destination G. Thus, the process by the control device 200 ends.

In FIG. 9, after the moving body 100 moves to the point P in the vicinity of the boundary, the route determination part 206 performs a determination on the basis of the same region as the predetermined region shown in FIGS. 6 to 8 (that is, the region surrounded by the straight lines L1 and L2). As an alternative method, the route determination part 206 may newly define the reference line RL from a point after the movement to the destination G every time the moving body 100 moves, then may define the predetermined region on the basis of the newly defined reference line RL and may perform the determination again.

### [Flow of Process]

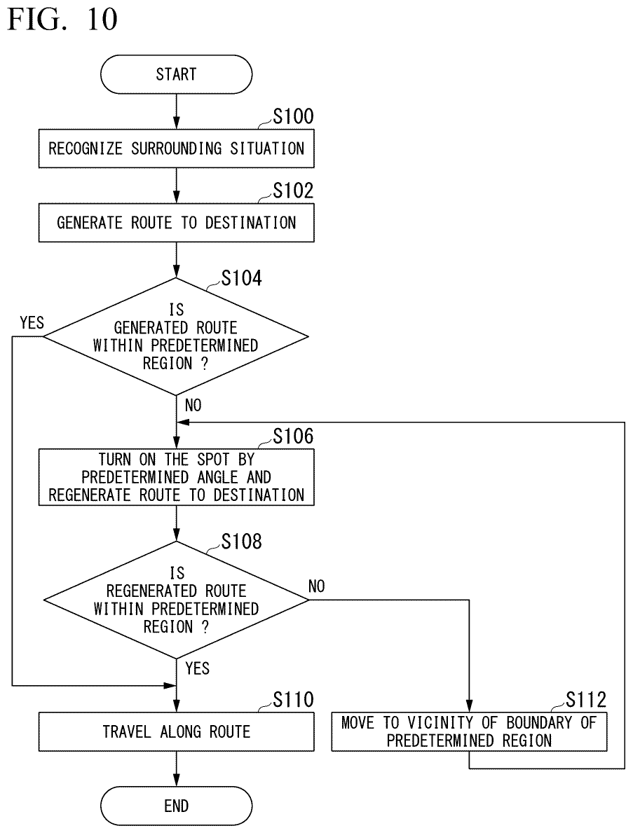

Hereinafter, a flow of the process performed by the control device 200 will be described with reference to FIG. 10. FIG. 10 is a flowchart showing an example of the flow of the process performed by the control device 200. The process shown in FIG. 10 is repeatedly performed while the moving body 100 is traveling in the following mode or the guidance mode.

First, the recognition part 202 recognizes the surroundings of the moving body 100 on the basis of at least images of the surroundings of the moving body 100 (Step S100). Next, the route generation part 204 generates a route from the moving body 100 to a destination on the basis of the recognized surrounding situations and the set destination (Step S102).

Next, the route determination part 206 determines whether or not the generated route is within the predetermined region defined by the current position of the moving body 100 and the destination (Step S104). When it is determined that the generated route is within the predetermined region, the drive control part 208 causes the moving body 100 to travel along the route generated by the route generation part 204 (Step S110).

On the other hand, when it is determined that the generated route deviates from the predetermined region, the drive control part 208 turns the moving body 100 on the spot by a predetermined angle, and the route generation part 204 regenerates a route to the destination (Step S106). Next, the route determination part 206 determines whether or not the regenerated route is within a predetermined region (Step S108). When it is determined that the regenerated route is within the predetermined region, the drive control part 208 causes the moving body 100 to travel along the route regenerated by the route generation part 204 (Step S110). On the other hand, when it is determined that the generated route deviates from the predetermined region, the drive control part 208 moves the moving body 100 to the vicinity of the boundary of the predetermined region. After that, the control device 200 returns the process to Step S106. Thus, the process of this flowchart ends.

In this embodiment, as an example, a case in which the destination is simply given as a point is described. However, the present invention is not limited to such a configuration, and the above control can be similarly applied even when the destination is given as a combination of a point and an orientation of the moving body. When the point and the target orientation of the moving body are given, the route generated or regenerated by the route generation part 204 may repeatedly deviate from the predetermined region (regeneration may fail a predetermined number of times or more). In this case, the control device 200 may overwrite the target orientation of the moving body with the orientation of the moving body 100 at the current position (or temporarily remove the target regarding the orientation of the moving body 100), and after reaching the target point, the drive control part 208 may turn the moving body 100 on the spot to match the target orientation of the moving body.

Furthermore, in this embodiment, when the route regenerated by the route determination part 206 deviates from the predetermined region, the drive control part 208 moves the moving body 100 to the vicinity of the boundary. However, the present invention is not limited to such a configuration, and when the route generated by the route determination part 206 (that is, the route generated for the first time, not regenerated) deviates from the predetermined region, the drive control part 208 may move the moving body 100 along the generated route in the vicinity of the boundary of the predetermined region and may perform a turn on the spot. Then, the route generation part 204 regenerates a route, and the route determination part 206 determines whether or not the regenerated route is within the predetermined region. That is, in the flowchart of FIG. 10, when a negative determination is made in Step S104, the process of Step S110 is performed, and then, the processes of Steps S106 and S108 are performed.

According to this embodiment described above, when the route generated by the route generation part 204 deviates from the predetermined region, the moving body 100 is turned on the spot and then the route is regenerated, and when the regenerated route is within the predetermined region, the moving body 100 is moved along the route. Thus, when a route to a destination is generated, it is possible to prevent generation of an inefficient route in terms of the orientation of the robot.

The above-described embodiment can be expressed as follows.

A control device for a moving body includes a storage medium configured to store computer-readable instructions, and a processor connected to the storage medium, wherein the processor executes the computer-readable instructions to recognize a surrounding situation of the moving body on the basis of at least an image of the surrounding situation of the moving body, to generate a route from the moving body to a destination on the basis of the recognized surrounding situation and the set destination, to determine whether or not the generated route is within a predetermined region defined by a current position of the moving body and the destination, to control the moving body so that the moving body moves along the generated route to the destination, and to turn the moving body on the spot and to regenerate a route from the moving body that has turned on the spot to the destination when it is determined that the route deviates from the predetermined region.

Although the embodiments of the present invention have been described above, the present invention is not limited to these embodiments in any way, and various modifications and substitutions can be made without departing from the spirit and scope of the present invention.

What is claimed is:

1. A control device for a moving body comprising:
a storage medium configured to store computer-readable instructions; and
a processor connected to the storage medium,
wherein the processor executes the computer-readable instructions to recognize a surrounding situation of a moving body based at least on an image of the surrounding situation of the moving body, to generate a route from the moving body to a destination based on the recognized surrounding situation and the set destination, to determine whether or not the generated route is within a predetermined region defined by a current position of the moving body and the destination, to control the moving body so that the moving body moves along the generated route to the destination, and to turn the moving body on a spot and to regenerate a route from the moving body that has turned on the spot to the destination when it is determined that the route has deviated from the predetermined region.

2. The control device for a moving body according to claim 1, wherein the processor determines whether or not the regenerated route is within the predetermined region, and
when it is determined that the regenerated route is within the predetermined region, the processor controls the moving body so that the moving body moves along the regenerated route to the destination.

3. The control device for a moving body according to claim 1, wherein the processor determines whether or not the regenerated route is within the predetermined region, and
when it is determined that the regenerated route has deviated from the predetermined region, the processor controls the moving body so that the moving body moves along the regenerated route to a vicinity of a boundary of the predetermined region, turns the moving body on the spot in the vicinity of the boundary of the predetermined region, and generates a route from the moving body that has turned on the spot to the destination.

4. The control device for a moving body according to claim 1, wherein the predetermined region is a region which represents a range within a predetermined distance from a reference line that connects the current position of the moving body and the destination.

5. The control device for a moving body according to claim 1, wherein the moving body is operated in either a following mode in which the moving body moves to follow a user, or a guide mode in which the moving body moves in front of the user at a moving speed corresponding to that of the user.

6. The control device for a moving body according to claim 5, wherein when the moving body is operated in the following mode, the destination is the user or a point within a predetermined range from the user.

7. The control device for a moving body according to claim 5, wherein when the moving body is operated in the guidance mode, the destination is a point set by the user or a point within a predetermined range in front of the user.

8. The control device for a moving body according to claim 5, wherein when the moving body is operated in the guidance mode, the destination is a temporary point that is temporarily set to reach a final point set by the user.

9. A control method for a moving body, wherein a computer recognizes a surrounding situation of a moving body based at least on an image of the surrounding situation of the moving body, generates a route from the moving body to a destination based on the recognized surrounding situation and the set destination, determines whether or not the generated route is within a predetermined region defined by a current position of the moving body and the destination, controls the moving body so that the moving body moves along the generated route to the destination, and turns the moving body on a spot and regenerates a route from the moving body that has turned on the spot to the destination when it is determined that the route deviates from the predetermined region.

10. A non-transient computer-readable storage medium for storing a program, wherein a computer is caused to recognize a surrounding situation of a moving body based at least on an image of the surrounding situation of the moving body, to generate a route from the moving body to the destination based on the recognized surrounding situation and the set destination, to determine whether or not the generated route is within a predetermined region defined by a current position of the moving body and the destination, to control the moving body so that the moving body moves along the generated route to the destination, and to turn the moving body on a spot and to regenerate a route from the moving body that has turned on the spot to the destination when it is determined that the route deviates from the predetermined region.
